(19) United States
(12) Patent Application Publication
(10) Pub. No.: US 2013/0336013 A1
(43) Pub. Date: Dec. 19, 2013

(54) DC-to-DC Converter and Method for Operating a DC-to-DC Converter

(71) Applicant: SMA Solar Technology AG, Niestetal (DE)

(72) Inventor: Burkhard Mueller, Kassel (DE)

(73) Assignee: SMA Solar Technology AG, Niestetal (DE)

(21) Appl. No.: 13/968,491

(22) Filed: Aug. 16, 2013

Related U.S. Application Data
(63) Continuation of application No. PCT/EP2011/052544, filed on Feb. 21, 2011.

(51) Int. Cl. H02M 3/335

(52) U.S. Cl. CPC H02M 3/3353
USPC 363/17

(57) ABSTRACT

The disclosure relates to a method for operating a DC-to-DC converter with two bridge arrangements with bridge switches, of which at least one is in the form of a switchable bridge arrangement which may be operated either as a full bridge or as a half bridge. The converter further includes a series resonant circuit, wherein the first and second bridge arrangements are coupled to one another via the series resonant circuit. At least one switchable bridge arrangement is operated as a full bridge in at least one time segment and as a half bridge in at least one further time segment within a half-period of a periodic switching of the bridge switches. The disclosure furthermore relates to a DC-to-DC converter and an inverter and a power generation installation including such a DC-to-DC converter.

### REFERENCE TO RELATED APPLICATION

This application is a continuation of International application number PCT/EP2011/052544 filed on Feb. 21, 2011.

### FIELD

The disclosure relates to a method for operating a DC-to-DC converter. The disclosure furthermore relates to a DC-to-DC converter, to an inverter and to an energy generation plant.

### BACKGROUND

DC-to-DC converters are used, for example, as input stages of an inverter, for example in a photovoltaic system, a combined fuel cell and heating system, or for battery-fed emergency power systems for a local energy supply system. In principle, a wide variety of topologies and operating methods are known for DC-to-DC converters. Resonant DC-to-DC converters are particularly suitable for transmitting relatively high powers, such as in the above mentioned application cases, for example, since, in comparison to hard-switching converters, a relatively high degree of efficiency may be achieved with the resonant DC-to-DC converters.

In addition, a higher switching frequency may also be selected than with a hard-switching converter and therefore, given the same degree of efficiency, the weight and volume of wound materials (inductors, possibly transformers) may be saved. Resonant DC-to-DC converters are in use in embodiments with series resonant circuits as well as with parallel resonant circuits. In particular when the DC-to-DC converter often operates in a partial load operating mode, such as in a photovoltaic system, for example, a DC-to-DC converter with a series resonant circuit is advantageous over one with a parallel resonant circuit due to lower losses in the partial load operating mode. For example, the voltage at the series resonant circuit is load-dependent and, at a reduced output power, the voltages present at the individual components (inductor, capacitor) are also lower. As a result of this, lower levels of re-magnetization losses (inductor) and dielectric losses (capacitor) occur. As a result, the efficiency is reduced to a lesser extent on a partial load than in the case of a DC-to-DC converter with a parallel resonant circuit. Furthermore, the voltages at the components are in principle lower in the case of a series resonant circuit. For this reason, the components may have smaller dimensions with respect to their volume and energy content, likewise entailing lower losses and costs.

One drawback with DC-to-DC converters with a series resonant circuit is reduced controllability. In many application cases, the voltage of a current source feeding the DC-to-DC converter is not constant. For example, the generator voltage changes in the case of a photovoltaic system when, dependent on the incident radiation and load, the working point of photovoltaic modules of the photovoltaic system is varied. In the case of a battery-fed standby power system, the battery voltage as an input voltage of the DC-to-DC converter is dependent on the load to be transmitted and the state of charge of the battery. Likewise, the cell voltage of a fuel cell as an input voltage of the DC-to-DC converter varies to a particular extent precisely in the low-load range. In such cases, it is desirable to provide a constant voltage as an input voltage for a circuit connected downstream of the DC-to-DC converter at the output of the DC-to-DC converter, for example an inverter bridge of an inverter. With a varying input voltage, this presupposes a variable voltage transformation ratio of the DC-to-DC converter.

Document U.S. Pat. No. 7,379,309 B2 discloses a DC-to-DC converter with a parallel resonant circuit, in which, in order to vary an output voltage, a variation in a switching frequency of the converter and/or a duty factor of switches in the converter is combined with switchover between a full-bridge and a half-bridge operating mode.

### SUMMARY

It is an aspect of the present disclosure to provide an operating method also for a DC-to-DC converter of the type mentioned at the outset, wherein the voltage transformation ratio may be varied in a simple manner with effective power transmission. It is a further aspect of the present disclosure to provide a DC-to-DC converter with improved voltage transformation variability, in particular suitable for implementing the operating method.

In accordance with a first embodiment, a method for operating a DC-to-DC converter comprises two bridge arrangements, of which at least one is configured as a switchable bridge arrangement with bridge switches selectively operable as a full bridge or as a half bridge, and a series resonant circuit, comprising at least one resonant inductance and at least one resonant capacitor, wherein the two bridge arrangements are coupled to one another via the series resonant circuit. The at least one switchable bridge arrangement is operated as a full bridge in at least one time segment and as a half bridge in at least one further time segment within a half-period of a periodic switching of the bridge switches.

The method therefore provides for switchover at least once between a half-bridge operating mode and a full-bridge operating mode within the duration of a half-period of the switching operation of the bridge switches. The duration of a half-period of the switching operation of the bridge switches in this case corresponds substantially to half the resonant period length of the series resonant circuit (resonant switching) or is slightly longer than this, for example (sub-resonant switching). Thus, the voltage transformation ratio may also be varied in the case of a DC-to-DC converter effectively operating in the partial-load range with a series resonant circuit. In this case, the magnitude of the voltage transformation ratio may be influenced via the duty factor of the switchover.

In the context of the application, a series resonant circuit is understood to mean a series circuit comprising an inductive element, also referred to as a resonant inductance below, for example a coil or an inductor, and a capacitive element, also referred to below as a resonant capacitor, wherein the total current flowing between the two bridge arrangements of the DC-to-DC converter is guided via the series circuit comprising this inductive element and this capacitive element. In addition, further inductive or capacitive elements may be connected between the two bridge arrangements, such as a transformer for galvanically isolating the two bridge halves, for example.

In one implementation of the method, an output voltage of the DC-to-DC converter is measured, and the lengths of the respective time segments for the half-bridge operating mode and the full-bridge operating mode are adjusted depending on a difference between the measured output voltage and a setpoint value for the output voltage. In this case the period of the switching of the bridge switches (and therefore the switching frequency) may be constant. This also applies in case of a variation of the lengths of the respective time segments for the half-bridge operating mode and the full-bridge operating mode with respect to one another. The total length of both time segments may thus be constant. In one embodiment the length of the time segments may be determined in a pulse width modulation method. In this way, an adjustment option for the voltage transformation ratio is provided.

In a further implementation of the method, the switchable bridge arrangement may be a secondary bridge arrangement. The secondary bridge arrangement may be operated within the half-period at first as a half bridge and subsequently as a full bridge. In this way, switching losses may be kept particularly low.

In yet a further implementation of the method, in addition one or more further measures for changing a voltage transformation ratio of the DC-to-DC converter may be implemented; for instance a transformation ratio of a transformer connected between the two bridge arrangements may be changed. Alternatively, the two bridge arrangements may be configured as switchable bridge arrangements, one of the two bridge arrangements being operated in the steady state either as a full bridge or as a half bridge for voltage range switchover. A steady-state change in a duty factor between a switch-on duration and a switch-off duration of bridge switches of one or both bridge arrangements may be performed as an additional further measure. A steady-state change in the sense of this description is in this case a change wherein, after the change, the changed values are kept constant over a time period longer than the period duration. The variation range of the voltage transformation ratio may be further increased via the measures.

In accordance with a second aspect, a DC-to-DC converter comprises two bridge arrangements with bridge switches, at least one of the bridge arrangements being configured as a switchable bridge arrangement, selectively operable as a full bridge or as a half bridge, and a series resonant circuit, comprising at least one resonant inductance and at least one resonant capacitor, wherein the first and second bridge arrangements are coupled to one another via the series resonant circuit. The DC-to-DC converter further comprises an actuation circuit configured to operate the at least one switchable bridge arrangement within a half-period of a periodic switching of the bridge switches as a full bridge in at least one time segment and as a half bridge in at least one further time segment.

In one embodiment of the DC-to-DC converter, a switching device is provided for selecting between the operation as full bridge and as half bridge. The at least one switchable bridge arrangement may comprise a bridge branch connected to a center tap of a capacitive voltage divider via the switching device. This represents a simple implementation of a switchable bridge arrangement.

In a further configuration of the DC-to-DC converter, a galvanically isolating transformer or a non-galvanically isolating transformation arrangement, for example in the manner of an autotransformer, is arranged between the first bridge arrangement and the second bridge arrangement. A stray inductance of the transformer may form part of the series resonant circuit. In this way, a separate resonant inductance may be provided with smaller dimensions or may be eliminated entirely.

In a further embodiment of the DC-to-DC converter, the transformer has two connections and one tap at least on one side, wherein optionally one of the connections or the tap is connected to a bridge branch via a switchover element. In this way, steady-state range switchover may be effected, further extending the variation range of the voltage transformation ratio.

In accordance with a third and fourth embodiment, an inverter comprises a DC-to-DC converter described above, and an energy generation plant comprises a DC source with a variable voltage connected to such an inverter.

### BRIEF DESCRIPTION OF THE DRAWINGS

The disclosure will be explained in more detail below using embodiments with the aid of four figures.

In the figures:

FIG. 1 shows a basic circuit diagram of a photovoltaic system with a DC-to-DC converter in a first embodiment,

FIG. 2 shows a graph illustrating switching times and current or voltage profiles for the DC-to-DC converter of the first embodiment,

FIG. 3 shows a second embodiment of a DC-to-DC converter in a basic circuit diagram,

FIG. 4 shows a third embodiment of a DC-to-DC converter in a basic circuit diagram.

### DETAILED DESCRIPTION

The disclosure relates to a method for operating a DC-to-DC converter comprising two bridge arrangements with bridge switches, at least one the bridge arrangements being configured as a switchable bridge arrangement selectively operable as a full bridge or as a half bridge, and a series resonant circuit comprising at least one resonant inductance and at least one resonant capacitor, the series resonant circuit coupling the two bridge arrangements to one another. The disclosure furthermore relates to a DC-to-DC converter suitable for implementing the method, to an inverter and to an energy generation plant.

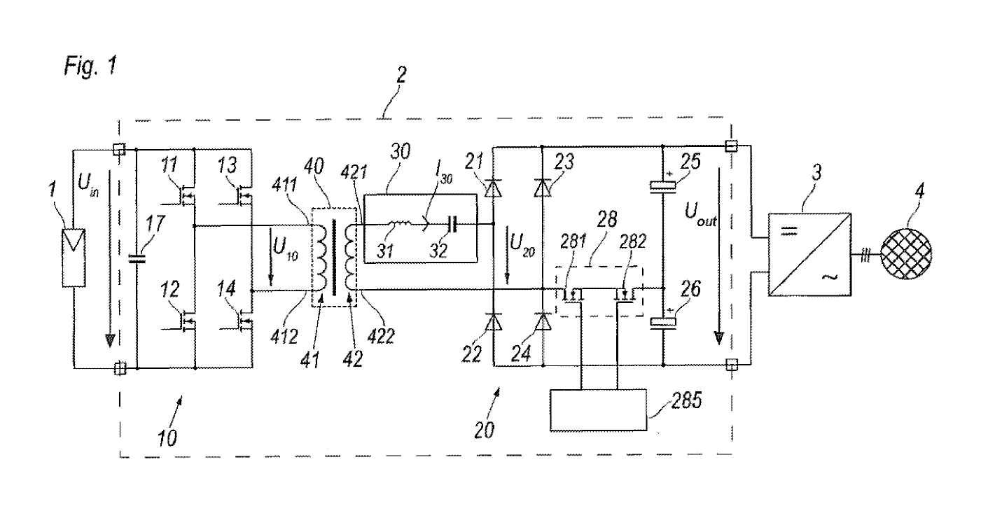

FIG. 1 shows a basic circuit diagram of a photovoltaic system as an example of an energy generation plant. The photovoltaic system comprises a photovoltaic generator 1 connected to a DC-to-DC converter 2. The DC-to-DC converter 2 is connected to an inverter 3 for converting the direct current delivered from the output of the DC-to-DC converter 2 into alternating current, and feeding it into an energy supply system 4. The DC-to-DC converter 2 and the inverter 3 may be separate components of the photovoltaic system, as illustrated. However, it is likewise possible to arrange the DC-to-DC converter 2 integrally in an inverter.

By way of example, the photovoltaic generator 1 is symbolized in FIG. 1 by the circuit symbol of an individual photovoltaic cell. In one embodiment of the photovoltaic system illustrated, the photovoltaic generator 1 may be a photovoltaic module or a plurality of photovoltaic modules connected in series and/or parallel.

The DC-to-DC converter 2 comprises two bridge arrangements 10, 20 connected to one another via a series resonant circuit 30 and a transformer 40. The DC-to-DC converter 2 illustrated is unidirectional, wherein the bridge arrangement 10 on the left-hand side in FIG. 1 represents the input stage of the DC-to-DC converter 2 with an input voltage Uᵢₙ. The bridge arrangement 20 illustrated on the right-hand side in FIG. 1 is the output stage of the DC-to-DC converter 2 with an output voltage Uₒᵤₜ. For simplified illustration, the input-side bridge arrangement 10 is also referred to below as the primary bridge arrangement 10, and the output-side bridge arrangement 20 is also referred to as the secondary bridge arrangement 20. It is noted that, in alternative configurations, the DC-to-DC converter may also be a bidirectional DC-to-DC converter. To this extent, the assignment of input and output voltages Uᵢₙ, Uₒᵤₜ to the bridge arrangements 10, 20 and the subdivision into an input stage and an output stage refer to this specific embodiment, but in principle are only an example and not restrictive.

In the illustrated embodiment, the primary bridge arrangement 10 is in the form of a so-called full bridge with two bridge branches, each having two bridge switches 11, 12 and 13, 14. For reasons of simpler assignment, the bridge switches 11-14 are also referred to below as primary bridge switches 11-14. By way of example, the primary bridge switches 11-14 in FIG. 1 are MOSFETs (metal oxide semiconductor field effect transistors). However. it is also possible and known at this point to use other power semiconductor switches, for example bipolar transistors or IGBTs (insulated-gate bipolar transistors). Depending on the type of transistor used, a freewheeling diode arranged back-to-back in parallel, also called anti-parallel, with the switching path of the transistor may be provided, either separately or integrated in the transistor. The voltage present at the output of the primary bridge arrangement 10, i.e. between the center taps of the two bridge branches, will be referred to below as central primary bridge voltage U₁₀. A smoothing capacitor 17 is also provided in parallel with the input in the case of the primary bridge arrangement 10.

In the illustrated embodiment, the transformer 40 may be a high-frequency transformer with a primary winding 41 and a secondary winding 42, each comprising two connections 411, 412 and 421, 422, with galvanic isolation. The primary winding 41 is in this case connected with in each case one of the connections 411, 412 to the center tap of, in each case, one bridge branch of the primary bridge arrangement 10 and the central primary bridge voltage U₁₀ is applied to the primary winding. The transformer 40 may have a transformation ratio of 1:1 or else may be designed to transform the voltage with a transformation ratio deviating from this. The transformation ratio is assumed to be fixed in this embodiment, since the transformer 40 does not have any influence on the variation of the voltage transformation ratio of the DC-to-DC converter 2, i.e. the ratio of the minimum to the maximum output voltage Uₒᵤₜ when the input voltage Uᵢₙ remains the same (or vice versa).

Alternatively, it is likewise possible to use a non-galvanically isolating transformation arrangement (not illustrated) instead of the transformer 40. Such a transformation arrangement has, for example, two current paths between in each case one of the bridge branches of the primary bridge arrangement 10 and the secondary bridge arrangement 20, and an arrangement comprising at least two inductances, wherein one of the inductances is arranged as a series inductance in one of the current paths, while the other inductance is present as a parallel inductance between the two current paths connecting the bridges. The latter may be used for switching load relief on the bridge switches without being part of a resonant circuit. It is noted that, even in the case of a galvanically isolating transformer, such as the transformer 40 shown, stray inductances of the windings 41, 42 influence the series resonant circuit 30 and in this sense may be considered to be part of the series resonant circuit. It is known that the stray inductance of a transformer is adjusted to a predetermined value by structural measures, with the result that under certain circumstances a separate inductor for forming the resonant inductance may be entirely removed.

In the same way as the primary bridge arrangement 10, the secondary bridge arrangement 20 also has two bridge branches, each having two bridge switches 21, 22 and 23, 24. In the embodiment illustrated in FIG. 1, diodes are used as secondary bridge switches 21-24. For reasons of simpler illustration, the secondary bridge switches 21-24 are also referred to as diodes 21-24 below. The secondary bridge arrangement 20 is consequently constructed with passive switching elements and not with actuable active switching elements. For this reason, the DC-to-DC converter may be operated unidirectionally. In an alternative configuration, where the secondary bridge switches 21-24 are also at least partially implemented as active switching elements, for example as transistors, the DC-to-DC converter may also operate bidirectionally.

The center tap of the bridge branch formed from the diodes 23 and 24 is connected directly to a connection 422 of the secondary winding 42. The center tap of the bridge branch formed from the diodes 21 and 22, on the other hand, is connected to the second connection 421 of the winding 42 via the series resonant circuit 30. The series resonant circuit 30 has a resonant inductance 31, for example a coil, and a resonant capacitor 32, as capacitive element connected in series therewith.

During operation of the DC-to-DC converter 2, the primary bridge switches 11-14 are switched in such a way that an alternating current flows through the series resonant circuit. Thus, an AC voltage, referred to below as the central secondary bridge voltage U₂₀, is applied to the center taps of the two bridge branches of the secondary bridge arrangement 20. In one embodiment, a switching frequency or period length is selected such that the alternating current or the central secondary bridge voltage U₂₀ has a frequency corresponding approximately to the resonant frequency of the series resonant circuit 30. In order to achieve effective power transmission, the primary bridge switches 11-14 may be switched with “soft” switching. Soft switching is understood as switching without current flowing (zero current switching, ZCS) and/or without a voltage applied to the switching element (zero voltage switching, ZVS). As already mentioned previously, stray inductances of the galvanically isolating transformer 40 may possibly be adjusted to desired values by known structural measures. To this extent, the stray inductance may be part of the resonant inductance of the series resonant circuit 30 and have a determining influence on the resonant frequency thereof.

The secondary bridge arrangement 20 has a capacitive voltage divider in the form of a series circuit comprising two capacitors 25, 26. The center tap of this series circuit comprising the two capacitors 25, 26 is connected to the center tap of the bridge branch formed from the diodes 23, 24 via a switching unit 28. In this embodiment, the switching unit 28 comprises two MOSFET transistors 281, 282 connected back-to-back in series and thus forming a bidirectional semiconductor switch. Further alternative embodiments of bidirectional semiconductor switches are known from the literature and may likewise be used.

If the switching unit 28 is switched off (open, nonconducting), the secondary bridge arrangement 20 operates as a full bridge, with the output voltage Uₒᵤₜ being equal to the peak value of the central secondary bridge voltage U₂₀. If the switching unit 28 is switched on, on the other hand, the secondary bridge arrangement 20 operates as a half bridge, with the output voltage Uₒᵤₜ being twice as high as the peak value of the central secondary bridge voltage U₂₀. Owing to its function as a changeover switch between the half-bridge operation and the full-bridge operation, the switching unit 28 is also referred to as a half-bridge/full-bridge changeover switch 28 below, H/F changeover switch 28 for short.

The DC-to-DC converter shown in FIG. 1 may consequently be operated in two different operating modes via the H/F changeover switch 28, the output voltage Uₒᵤₜ differing by a factor of 2 between the modes given the same input voltage Uᵢₙ. Correspondingly, the voltage transformation ratio in the two operating modes likewise differs by a factor of 2.

In an operating method according to the application, provision is conversely made for the secondary bridge arrangement 20 to be switched over at least once between a half-bridge operating mode and a full-bridge operating mode via the H/F changeover switch 28 within the duration of each period of the switching of the bridge switches 11-14, 21-24. Possibly, this switchover may also be performed a plurality of times within a period duration. In contrast to the “steady-state” switchover, in which an operating mode (half-bridge operating mode or full-bridge operating mode) is maintained over a period of time which is long in comparison with a period duration, the switchover within each period is referred to below as a “dynamic” switchover.

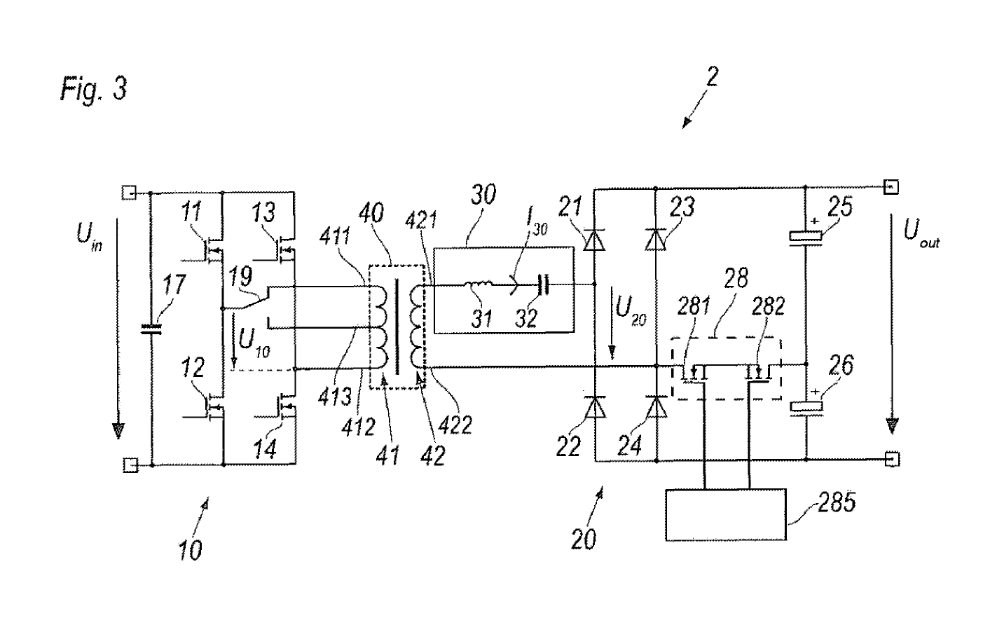

In the secondary-side arrangement of the H/F changeover switch 28 shown, switchover from a half-bridge operating mode to a full-bridge operating mode, i.e. opening of the H/F changeover switch 28, during the course of a period is advantageous. The H/F changeover switch 28 is in this case closed again between successive periods. Similarly, in the case of a primary-side arrangement of the H/F changeover switch, as is illustrated in FIG. 3, for example, a change from the full-bridge mode to the half-bridge mode by closing of the H/F changeover switch within the period is advantageous, but this generally is associated with relatively high switching losses. Therefore, the secondary-side arrangement of the H/F changeover switch 28 shown is desirable in one embodiment.

In order to implement the described method, a control device 285 is provided for correspondingly actuating the transistors 281, 282 of the H/F changeover switch 28. The control device 285 may also perform the function of actuating all of the active bridge switches, i.e. in the embodiment actuating the primary bridge switches 11-14. This is not illustrated in FIG. 1 for reasons of clarity.

Such a dynamic switchover between the full-bridge operating mode and the half-bridge operating mode within a period enables the adjustment of an output voltage Uₒᵤₜ between the two limit voltages set at the output during continuous operation as half bridge or full bridge. Thus, the output voltage Uₒᵤₜ in the case of a constant input voltage Uᵢₙ may be varied between the two previously mentioned limit values by a variation of, for example, the duty factor between actuation and non-actuation of the H/F changeover switch 28. Correspondingly, the voltage transformation ratio may be changed continuously from 1:1 to 1:2, with in this case a transformer with a transformation ratio of 1:1 being assumed by way of example. Correspondingly, with a varying input voltage Uᵢₙ of the DC-to-DC converter 2, an output voltage Uₒᵤₜ may also be kept constant when the input voltage varies by up to the mentioned factor of 2. For a regulation of the output voltage Uₒᵤₜ or an adjustment of the voltage transformation ratio, the control device 285 may use a pulse width modulation method (PWM method). In this case, the period of the switching of the bridge switches 11-14, 21-24 is not changed. The DC-to-DC converter is thus operated at resonance over the entire adjustment range.

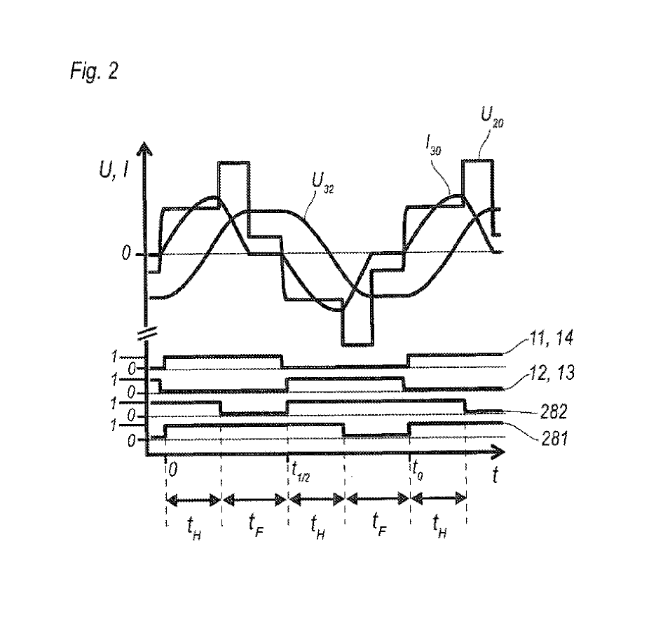

FIG. 2 illustrates, using voltage profiles of actuation signals and of voltages and currents observed within the DC-to-DC converter shown in FIG. 1, an embodiment of an operating method for a DC-to-DC converter.

The lower part of FIG. 2 shows the voltage profiles of actuation signals of the primary bridge switches 11, 14 and 12, 13 and of the transistors 281, 282 of the H/F changeover switch 28 as a function of time t. The repetition rate of the periodic actuation of the bridge arrangements is illustrated as period t₀ and is divided into two half-periods with a duration of t_{1/2}. In the case of the actuation signals, in each case a “1” indicates a switched-on switch and a “0” indicates a switched-off switch.

The upper part of FIG. 2 shows the central secondary bridge voltage U₂₀, the voltage drop across the resonant capacitor 32, and the current flowing through the series resonant circuit 30. The latter are denoted as U₃₂ and I₃₀, respectively. The DC-to-DC converter is operated at resonance, as may be seen from the fact that the duration of a resonance half-cycle of the current I₃₀ substantially corresponds to the duration t₁₂ of a half-period for the switching of the primary bridge switches 11-14.

In time segments t_{H}, both transistors 281 and 282 are actuated (on), and the secondary bridge 20 is operated as a half-bridge. If one of the two transistors 281 and 282 is not actuated, the secondary bridge 20 is operated as a full-bridge (time segments t_{F}). In each half-cycle of the resonant current I₃₀, the secondary bridge 20 is initially operated as a half bridge and subsequently as a full bridge. Therefore, two time segments t_{H} and two time segments t_{F} are present within a period duration. The graph also shows that the primary bridge switches 11-14 are switched in a de-energized state, i.e. soft switching takes place resulting in an improved efficiency of the DC-to-DC converter 2.

FIG. 3 shows a further implementation of a DC-to-DC converter in a basic circuit diagram. Identical or functionally corresponding elements are provided with the same reference symbols in FIG. 3 as in FIG. 1.

The DC-to-DC converter illustrated in FIG. 3 is a further development of the DC-to-DC converter in FIG. 1 and differs from this in that a transformer 40 is used whose primary winding has an inner tap 413 in addition to the connections 411 and 412. This tap 413 is connected to the center tap of the bridge branch formed from the bridge switches 11 and 12 via a switchover element 19. When the switchover element 19 is in the upper position, the primary bridge voltage U₁₀ is applied to the entire winding 41 of the transformer 40 between the connections 411, 412. In the lower position of the switchover element 19, on the other hand, the central primary bridge voltage U₁₀ is applied to part of the first winding 41 between the tap 413 and the connection 412. Correspondingly, a different transformation ratio results from the central primary bridge voltage U₁₀ to the central primary bridge voltage U₂₀.

Symbolically, the switchover element 19 is illustrated by the circuit symbol for a single changeover switch in FIG. 2. However, the changeover switch may as well comprise a plurality of semiconductor elements, for example an arrangement comprising transistors and possibly diodes.

With the aid of the switchover element 19, steady-state switchover of the voltage transformation ratio may be performed or combined with dynamic switchover in the secondary bridge arrangement via the H/F changeover switch 28. If the tap 413 is configured to change the voltage transformation through steady-state switchover by a factor of 2, a quasi-continuous variation by a factor of 4 is possible in combination with the dynamic switchover. If, for example, the duty factor of the H/F changeover switch 28 is first varied between 0 and 1 when the changeover element 19 is open and then the duty factor at the H/F changeover switch 28 is in turn varied from 0 to 1 when the switchover element 19 is closed, the voltage transformation ratio may be varied by a factor of 4 without interruption.

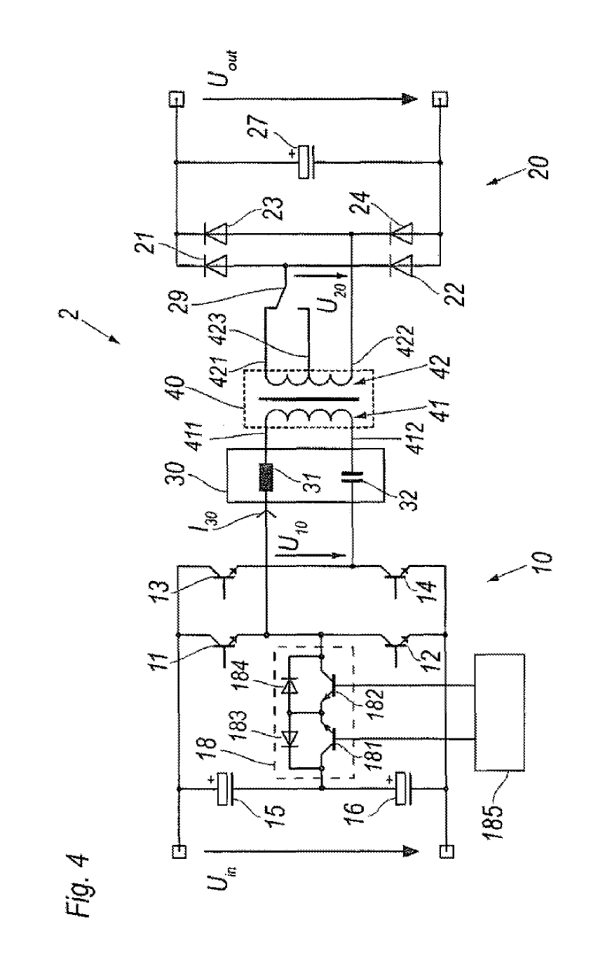

Similarly to in this case, by changing the transformation ratio of the transformer 40, further steady-state methods for changing the voltage transformation ratio of the DC-to-DC converter with continuous variation via the dynamic actuation of the H/F changeover switch 28 may also take place. For example, the primary-side bridge arrangement 10 may also be a switchable bridge arrangement operated as a half bridge or full bridge. A primary-side steady-state switchover enables a change in the voltage transformation ratio by a factor of 2, optionally combined with the described continuous variation in the voltage transformation ratio by the secondary-side H/F changeover switch 28. A combination of a plurality of steady-state switchovers with a dynamic switchover is also possible. For example, the steady-state change in the voltage transformation ratio shown in FIG. 3 by means of an additional tap 413 on the transformer 40 may be combined with a steady-state switchover by the switchover element 19 by a factor of 2 by the half-bridge/full-bridge switchover in the case of the primary bridge arrangement 10, with a further steady-state switchover by an additional tap on the transformer on the secondary side together with corresponding steady-state switchover (as illustrated in FIG. 4, for example) and with the continuous variation by dynamic switchover of the H/F changeover switch 28. The variation range of the voltage transformation ratio may be further increased by such a combination.

FIG. 4 shows a further embodiment of a DC-to-DC converter in a basic circuit diagram. Identical or functionally identical elements have been provided with the same reference symbols here too as in the previous embodiments.

The DC-to-DC converter shown in FIG. 4 comprises a primary-side bridge arrangement 10 and a secondary-side bridge arrangement 20 coupled to one another via a series resonant circuit 30 and a transformer 40. In contrast to the previously shown embodiments, the primary bridge arrangement 10 is configured as a switchable bridge arrangement operable as a half bridge or a full bridge. For this purpose, the primary bridge arrangement 10 comprises, in addition to switchable bridge branches with primary bridge switches 11 and 12 and 13 and 14, respectively, a capacitive voltage divider as third branch comprising two capacitors 15, 16 in a series circuit. By way of example, the bridge switches 11-14 may be bipolar transistors as shown in FIG. 4. The freewheeling diodes connected anti-parallel with the bridge switches 11-14 are not shown.

In order to switch over between operating modes as a half-bridge and full-bridge, the center tap between the capacitors 15 and 16 is connected to the center tap between the bridge switches 11 and 12 via a switching unit 18. With regard to the function, the switching unit 18 will be referred to below as an H/F changeover switch 18. The H/F changeover switch 18 may be by transistors 181 and 182 connected back-to-back in series, with in each case one freewheeling diode 183, 184 arranged anti-parallel therewith. In this case, bipolar transistors are used as transistors 181 and 182. They are actuated by a control device 185 also performing the actuation of the bridge switches 11-14 in a manner similar to the control device 285 in FIG. 1. The function of the smoothing capacitor 17 from the embodiment in FIG. 1 is provided by the capacitors 15 and 16.

The secondary bridge arrangement 20 is configured as a full-wave rectifier bridge with four diodes as bridge switches 21-24 and a smoothing capacitor 27 connected in parallel with the output.

The series resonant circuit 30 comprises, as previously, a coil as resonant inductance 31 and a resonant capacitor 32, wherein, in contrast to the previous embodiments, the series resonant circuit 30 is arranged on the primary side in this embodiment. As a further difference, the resonant inductance 31 and the resonant capacitor 32 are not connected directly in series, but via the winding 41 of the transformer 40. However, this does not change the previously mentioned characteristic of the series resonant circuit 30, as the total current flow between the primary bridge arrangement 10 and the secondary bridge arrangement 20 is guided via the series circuit comprising the resonant inductance 31 and the resonant capacitor 32.

Similarly to the above-described embodiments, the primary-side H/F changeover switch 18 may also be switched within a half-period, resulting in the primary-side bridge arrangement 10 operating temporarily as a half bridge and temporarily as a full bridge during a half-period of the switching of the bridge switches 11-14, 21-24. Again, a PWM method may be used. As a result, the voltage transformation ratio may also be varied continuously by a factor of 2 in this way. Due to the differing current and voltage profiles within a primary-side bridge arrangement as compared to a secondary-side bridge arrangement, it is not possible to apply soft switching to all of the bridge switches in the bridge arrangement. Therefore, the primary-side dynamic H/F switchover may be less attractive than a secondary-side H/F switchover.

As before, a range switchover may be additionally provided by changing the transformation ratio of the transformer 40, here on the secondary side instead of the primary side. For this purpose, the secondary-side winding 42 of the transformer 40 comprises an inner tap 423 in addition to the connections 421, 422, wherein a switchover element 29 selectively connects the connection 421 or the tap 423 to the center tap of the bridge branch formed from the diodes 21 and 22. Analogously to the primary-side range switchover, the transformation ratio from the central primary bridge voltage U₁₀ to the central primary bridge voltage U₂₀ and therefore the voltage transformation ratio of the DC-to-DC converter 2 may also be varied in steady-state fashion in this way.

In an alternative configuration, the primary-side H/F changeover switch 17 shown may also be used for steady-state range switchover, however, and may be combined with a dynamic secondary-side H/F switchover, as has been explained in connection with FIG. 3.

Furthermore, in a further alternative configuration, it is conceivable to equip both sides of the DC-to-DC converter, i.e. the primary-side bridge arrangement and the secondary-side bridge arrangement, with a dynamic H/F switchover. In this way, continuous variation of the voltage transformation ratio by a factor of 4 may be provided.

Furthermore, it is possible to perform the measures previously described as steady-state means for range switchover, for example the switchover between connections and inner taps in the case of a transformer, dynamically, i.e. within the half-periods of the switching of the bridge switches.

The disclosure is not restricted to the embodiments described, but may be modified in a variety of ways and supplemented by a person skilled in the art. In particular it is possible to also implement the measures in other combinations than those explicitly mentioned, and to supplement further previously known procedures for changing the voltage transformation ratio of the DC-to-DC converter.

1. A method for operating a DC-to-DC converter, comprising
two bridge arrangements each comprising bridge switches, wherein at least one of the bridge arrangements is configured as a switchable bridge arrangement selectively operable as a full bridge or a half bridge, and
a series resonant circuit, comprising at least one resonant inductance and at least one resonant capacitor, wherein the two bridge arrangements are coupled to one another via the series resonant circuit,
wherein the method comprises operating at least one switchable bridge arrangement, within a half-period of a periodic switching of the bridge switches, as a full bridge in at least one time segment and as a half bridge in at least one further time segment.

2. The method as claimed in claim 1, wherein an output voltage Uₒᵤₜ of the DC-to-DC converter is measured, and wherein the lengths of the time segments are adjusted depending on a difference between the measured output voltage Uₒᵤₜ and a setpoint value for the output voltage.

3. The method as claimed in claim 1, wherein the lengths of the time segments are determined using a pulse width modulation method.

4. The method as claimed in claim 1, wherein a switching duration of the bridge switches is constant.

5. The method as claimed in claim 1, wherein the switchable bridge arrangement is a secondary bridge arrangement on an output side of the series resonant circuit.

6. The method as claimed in claim 5, wherein the secondary bridge arrangement is operated, within the half-period, initially as a half bridge and subsequently as a full bridge.

7. The method as claimed in claim 1, further comprising one or more additional measures for changing a voltage transformation ratio of the DC-to-DC converter.

8. The method as claimed in claim 7, wherein as an additional measure, a transformation ratio of a transformer connected between the two bridge arrangements is changed.

9. The method as claimed in claim 7, wherein the two bridge arrangements are both configured as switchable bridge arrangements, wherein one of the switchable bridge arrangements is operated in a steady state either as a full bridge or as a half bridge for voltage range switchover.

10. The method as claimed in claim 7, wherein, as an additional measure, a steady-state change in a duty factor between a switch-on duration and a switch-off duration of bridge switches of one or both bridge arrangements is performed.

11. A DC-to-DC converter, comprising:
two bridge arrangements each comprising bridge switches, wherein at least one of the bridge arrangements is configured as a switchable bridge arrangement selectively operable as a full bridge or as a half bridge;
a series resonant circuit comprising at least one resonant inductance and at least one resonant capacitor, wherein the first bridge arrangement and the second bridge arrangement are coupled to one another via the series resonant circuit; and
an actuation circuit configured to operate the at least one switchable bridge arrangement within a half-period of a periodic switching of the bridge switches as a full bridge in at least one time segment and as a half-bridge in at least one further time segment.

12. The DC-to-DC converter as claimed in claim 11, further comprising a switching device configured to switch the at least one switchable bridge arrangement between the operation as full bridge and as half bridge in response to the actuation circuit.

13. The DC-to-DC converter as claimed in claim 12, wherein the at least one switchable bridge arrangement comprises a bridge branch connected to a center tap of a capacitive voltage divider via the switching device.

14. The DC-to-DC converter as claimed in claim 11, further comprising a galvanically isolating transformer arranged between the two bridge arrangements.

15. The DC-to-DC converter as claimed in claim 14, wherein a stray inductance of the transformer forms part of the series resonant circuit.

16. The DC-to-DC converter as claimed in claim 14, wherein the transformer has two connections and a tap at least on one side, wherein optionally one of the connections or the tap is connected to a bridge branch via a switchover element.

17. The DC-to-DC converter as claimed in claim 11, further comprising a switchover element configured to operate one of the two bridge arrangements in a steady state either as a full bridge or as a half bridge for voltage range switchover.

18. The DC-to-DC converter as claimed in claim 11, further comprising a non-galvanically isolating transformation arrangement arranged between the two bridge arrangements.

19. An inverter comprising a DC-to-DC converter, wherein the DC-to-DC converter comprises:
two bridge arrangements each comprising bridge switches, wherein at least one of the bridge arrangements is configured as a switchable bridge arrangement selectively operable as a full bridge or a half bridge, and
a series resonant circuit, comprising at least one resonant inductance and at least one resonant capacitor, wherein the two bridge arrangements are coupled to one another via the series resonant circuit,
wherein the at least one switchable bridge arrangement is configured to be operated, within a half-period of a periodic switching of the bridge switches, as a full bridge in at least one time segment and as a half bridge in at least one further time segment.

20. An energy generation plant comprising a DC source with a variable voltage connected to a DC-to-DC converter, wherein the DC-to-DC converter comprises:
two bridge arrangements each comprising bridge switches, wherein at least one of the bridge arrangements is configured as a switchable bridge arrangement selectively operable as a full bridge or a half bridge, and
a series resonant circuit, comprising at least one resonant inductance and at least one resonant capacitor, wherein the two bridge arrangements are coupled to one another via the series resonant circuit,
wherein the at least one switchable bridge arrangement is configured to be operated, within a half-period of a periodic switching of the bridge switches, as a full bridge in at least one time segment and as a half bridge in at least one further time segment.
